(19) United States
(12) Patent Application Publication
(10) Pub. No.: US 2016/0090002 A1
(43) Pub. Date: Mar. 31, 2016

(54) Cooling System For Cooling An Energy Accumulator And A Charge Controller For A Vehicle With An Electric Drive

(71) Applicant: SIEMENS AKTIENGESLLSCHAFT, Munchen (DE)

(72) Inventor: MAIK NOACK, SPREEWALDHEIDE / OT LAASOW (DE)

(21) Appl. No.: 14/892,884

(22) PCT Filed: May 20, 2014
(86) PCT No.: PCT/EP2014/060292

§ 371 Date: Nov. 20, 2015

(30) Foreign Application Priority Data
May 24, 2013 (DE) 10 2013 209 706.9

(51) Int. Cl. B60L 11/18; H01M 10/46; H01M 10/6568; H01M 10/667; H01M 10/613; H01M 10/625

(52) U.S. Cl. CPC B60L 11/1874; H01M 10/613; H01M 10/625; H01M 10/6568; H01M 10/667; H01M 10/46; B60L 11/1809; H01M 2220/20

(57) ABSTRACT

A vehicle has an electric drive, at least one energy accumulator for supplying the electric drive with electric energy, and at least one current collector for charging the energy accumulator with electric energy from a stationary power network. The current collector is connected to the energy accumulator via at least one charge rectifier for the controlled charging of the energy accumulator. The vehicle includes a central cooling system and at least one closed cooling circuit with liquid coolant in order to cool the energy accumulator and the charge rectifier.

The invention relates to a vehicle comprising at least one electric drive and at least one energy accumulator for supplying the electric drive with energy, wherein the vehicle comprises at least one current collector for charging the energy accumulator with electrical energy from a stationary power network, to which current collector the energy accumulator is connected via at least one charge converter for controlled charging of the energy accumulator.

A prototype of such an accumulator system is used in a public transport rail vehicle manufactured by Siemens AG under the name Combino in the operation of Metro Transportes Sul do Tejo in Lisbon and serves there fundamentally to receive and temporarily store braking energy that cannot be fed back. As energy accumulator, the vehicle comprises a battery and a capacitive accumulator, consisting of a plurality of double-layer capacitors. For cooling of the battery, a water-air cooling system is used, which cools the battery with water, wherein the water is re-cooled by means of water-air heat exchangers. The capacitor accumulator, by contrast, is cooled with air, as are charge converters and on-board network converters, for the cooling of which dedicated air heat exchangers and fans are provided. Further passive components, such as smoothing chokes, are either arranged in the airflow of the specified devices, or are cooled by convection. This system is known as hybrid energy storage.

The object of the invention is to propose a vehicle of the type mentioned in the introduction that can be produced in a compact and economical manner.

The object is achieved by the subject matter of independent claim 1. Developments and embodiments of the invention can be found in the features of the dependent claims.

A vehicle according to the invention, in particular a public transport rail vehicle, comprises at least one electric drive and at least one rechargeable energy accumulator, and from now on at least one charge converter and at least one current collector for charging the energy accumulator with electric energy from a stationary power network, to which current collector the energy accumulator is connected via the at least one charge converter for controlled charging and discharging of the energy accumulator. In addition, the vehicle comprises in accordance with the invention a central cooling system and at least one closed cooling circuit with liquid coolant in order to cool the energy accumulator and the charge converter. The cooling system may be referred to colloquially as an air-conditioning system. The electric drive comprises in particular at least one electric motor for driving the vehicle.

Both the at least one energy accumulator and the at least one charge converter are each assigned at least one heat exchanger. In a first variant of the invention the heat exchangers are arranged in the same closed cooling circuit. In particular, the at least one heat exchanger of the at least one charge converter is then arranged before the at least one heat exchanger of the at least one energy accumulator, starting from the central cooling system. In accordance with a further variant of the invention the at least one heat exchanger of the at least one energy accumulator is arranged in a first, in particular closed, cooling circuit and the at least one heat exchanger of the at least one charge converter is arranged in a second cooling circuit, which in particular is closed and is different from the first cooling circuit. Both the common cooling circuit and the first and the second cooling circuit are connected to the common central cooling system, for example via at least one central heat exchanger of the central cooling system. Besides the central heat exchanger, the central cooling system further comprises, in a development, at least one condenser, at least one compressor and at least one evaporator. The central cooling system from now on comprises a choke between the condenser and the evaporator where necessary. Furthermore, the central cooling system has at least one fan. Alternatively, the central heat exchanger of the central cooling system is formed as a passive liquid-air heat exchanger, whereby it is possible to dispense with the condenser, the compressor and the evaporator. By comparison, the cooling capacity may thus be significantly reduced, but may be sufficient with use of energy accumulators having greater temperature ranges.

A cooling circuit generally consists of pipelines and, where appropriate, recirculating pumps. A liquid coolant circulating in the cooling circuit is guided past the at least one energy accumulator and/or past the at least one charge converter as heat sources, in particular through the heat exchanger associated with the at least one energy accumulator and the at least one charge converter, heats up during this process and releases the absorbed heat again to the central cooling system as heat sink. For applications with high ambient temperatures, the heat sink is formed by a refrigerating machine. If high ambient temperatures are not present, a passive liquid-air heat exchanger could form the heat sink. If the central cooling system is operated inversely, it thus forms the heat source and the at least one energy accumulator and/or the at least one charge converter forms/form the heat sinks, such that they may be heated at ambient temperatures that are below their own temperatures. This may be the case for example in standby mode. Alternatively, the vehicle comprises at least one heating element, which is arranged in at least one cooling circuit, in order to heat the liquid coolant. In order to control the coolant flow through a predefined heat exchanger, the vehicle in particular has at least one valve, which is arranged in the cooling circuit before the predefined heat exchanger.

The at least one, closed cooling circuit with liquid coolant, in a development, comprises at least one recirculating pump. If two or more cooling circuits are provided, each in particular has at least one recirculating pump. Coolants are substances or substance mixtures used to transport away heat. A liquid coolant is present here in liquid form, at least in laboratory conditions (20° C., 1013 mbar).

The at least one energy store, in particular at least one rechargeable battery and/or at least one capacitor accumulator, may comprise a plurality of storage elements, for example galvanic cells or a plurality of capacitors. The at least one energy accumulator is suitable in particular for storing electrical energy and may also be referred to as a current accumulator. Equally, the vehicle may have a plurality of charge converters, in particular for the controlled charging and/or discharging of the storage elements. For example, the number of storage elements and of charge converters may be the same. In a development, the vehicle has a plurality of heat exchangers for the at least one energy accumulator and/or the vehicle comprises a plurality of heat exchangers for the at least one charge converter. In accordance with an embodiment, the energy accumulator comprises a plurality of storage elements, each of which is associated with a heat exchanger. In accordance with a further embodiment, the vehicle comprises a plurality of charge converters, each of which is likewise associated with a heat exchanger. The heat exchangers for the charge converters, and also the heat exchangers for the storage elements, serve in particular to cool the charge converters and storage elements respectively.

Further variants are conceivable. By way of example, a heat exchanger may be assigned to two or more storage elements. Similarly, a heat exchanger may be assigned to two or more charge converters.

Alternatively, the charge converters and the storage elements are each arranged on common cooling plates, which in particular are different from one another and are arranged separately from one another. At least one or more heat exchangers is/are then provided in turn for each cooling plate in one or more cooling circuits to the central air-conditioning system.

If a plurality of heat exchangers are provided for the at least one energy store and/or for the at least one charge converter, the corresponding cooling circuit has a plurality of branches. The individual strands of the cooling circuit however, which are created by a branching and lead to the individual heat exchangers, will be combined again later, in particular after the heat exchangers as considered from the central cooling system, such that reference can be made to a cooling circuit.

In order to adapt the cooling of the storage elements and/or of the charge converters, the vehicle may have a plurality of valves for controlling the coolant flow through the heat exchangers of the storage elements and/or the charge converters, which valves, starting from the central cooling system, are arranged before the heat exchangers of the storage elements and/or before the heat exchangers of the charge converters. In particular, a valve is arranged before each heat exchanger. It is thus possible not only for the storage elements and the charge converters to be cooled differently, in particular in accordance with their thermal load, but also for the storage elements to be cooled differently from one another and for the charge converters to be cooled differently from one another. An optimal operating temperature of the individual storage elements and/or of the charge converters can be set relatively easily.

If the at least one heat exchanger of the at least one energy accumulator and the at least one heat exchanger of the at least one charge converter are arranged in the same cooling circuit, a development is thus provided in accordance with which the heat exchanger of the charge converter is arranged before the heat exchanger of the energy accumulator, starting from the central cooling system. In accordance with a further development at least one valve is then provided for controlling the coolant feed to the heat exchanger of the energy accumulator in the cooling circuit, which valve is arranged after the heat exchanger of the charge converter and before the heat exchanger of the energy accumulator, starting from the central cooling system. The valve serves to meter the coolant feed and thus to control the temperature of the at least one energy store and may therefore also be referred to as a choke.

For applications with greater climatic demands or greater demands on the energy accumulator, a vehicle that can be produced in a compact and economical manner is provided in accordance with the invention. An increased demand on the energy accumulator may be provided for example in catenary-free operation, in which the vehicle draws its energy only by charging at charging stations located at the stopping points and is otherwise fed from the accumulator system. Such permanent charge and discharge cycles with high powers cause higher charge losses in the accumulators, which requires a higher cooling capacity.

The storage media used for the energy accumulators require narrow temperature limits to be observed. In fields of use with high ambient temperatures, air temperature maxima may exceed these temperature limits, which requires a cooling with water, combined with a re-cooling of the cooling circuit by means of a refrigerating machine.

In a further development of the invention the heat exchanger of the at least one energy accumulator is arranged in a first cooling circuit and the heat exchanger of the at least one charge converter is arranged in a second cooling circuit, which is different from the first cooling circuit, wherein, in order to cool the at least one energy accumulator and the at least one charge converter differently, at least one valve for controlling a coolant flow through the first and/or the second cooling circuit is arranged in the first and/or in the second cooling circuit.

The vehicle thus comprises at least two separate cooling circuits, which are connected to the common central cooling system and for example use the same central heat exchanger of the central cooling system jointly. In accordance with one design, a common pipeline leads through the central heat exchanger in order to cool the liquid coolant in the pipeline. After the central heat exchanger, as considered in the direction of flow of the coolant, a branching of the pipeline follows, i.e. the cooling circuits branch out. One leads the coolant to the at least one heat exchanger of the at least one energy accumulator, the other leads the coolant to the at least one heat exchanger of the at least one charge converter. Both cooling circuits combine again before the central heat exchanger of the central cooling system.

At least one of the two cooling circuits, i.e. the first and/or the second cooling circuit, extending separately or in a branched manner, here comprises in particular at least one heating element. The respective temperatures of the at least one energy accumulator and also of the at least one charge converter are controlled accordingly by means of the common cooling system and/or the at least one heating element.

Here, the heating element is arranged in particular after the central heat exchanger of the central cooling system and where applicable after a branch in the individual cooling circuits, in particular directly before the at least one heat exchanger of the at least one charge converter and/or in particular directly before the at least one heat exchanger of the at least one energy accumulator.

If the heat exchangers of the energy accumulator and of the charge converter are arranged in a common cooling circuit, at least one central heating element may also be arranged in the cooling circuit in order to heat the energy accumulator and/or the charge converter to a predefined operating temperature. Alternatively, the central cooling system could be operated inversely, or each storage element and/or each charge converter could have a heating element in the immediate vicinity.

Generally, an electric drive can also be used as an additional drive, for example in a hybrid drive, or as an auxiliary drive. In particular, the electric drive comprises at least one electric motor, but in particular a plurality of electric motors, for driving the vehicle. The vehicle is developed exclusively by means of the electric drive, in particular by means of the at least one electric motor, in particular by means of the plurality of electric motors of the electric drive. The vehicle is in particular a large-scale vehicle for transporting people or goods. In a development, the vehicle is a public transport rail vehicle, in particular an at least two-part or multi-part rail vehicle, for example a low-floor tram. The at least one energy accumulator can provide the energy for operating the at least one electric drive and therefore for driving the rail vehicle and is dimensioned and designed accordingly. In contrast to similar systems of a passenger vehicle, for example with hybrid drive with a corresponding electric motor as electric drive and an energy accumulator, the electric powers received by the energy accumulator and the charge controller are considerably increased. Accordingly, more efficient and more complex systems must be provided, in particular for a self-sufficient drive by means of the energy accumulator, with, in particular exclusively, ad hoc charging of the energy accumulator. Start-up and braking procedures often take place with extensive and even complete discharge of one or more storage elements of the energy accumulator. The frequency of the complete charging and discharging procedures is comparatively reduced in the specified passenger vehicles. In addition, the spatial conditions in an optionally multi-part rail vehicle with a drive distributed among the vehicle parts are significantly different from the spatial conditions in a passenger vehicle. The cooling systems alone of a public transport rail vehicle, said cooling systems being provided in order to cool the public areas for passengers, deviate significantly in terms of their dimensions from the cooling systems of a passenger vehicle. Depending on the spatial or physical conditions, the devices for traction, energy storage, on-board network power supply and/or air conditioning are to be spatially separated from one another.

A charge converter, i.e. a DC chopper having the function of a charge controller, is suitable for controlling a charging and discharging of the at least one energy accumulator and is designed accordingly. In order to charge the at least one energy accumulator, the at least one charge converter is connected between the stationary power network and the energy accumulator, and for discharge the at least one charge converter is connected between the at least one energy accumulator and the at least one electric drive the vehicle.

Besides the at least one charge converter, the vehicle may comprise further power electronic devices for voltage conversion for feeding on-board networks, for example at least one on-board network converter and/or at least one charging device for an optionally provided on-board network battery and/or at least one traction power converter. In order to cool the on-board network converter and/or the charging device for the on-board network battery and/or the traction power converter, at least one heat exchanger, and in particular at least one heat exchanger for each of the aforementioned parts, is/are arranged in at least one cooling circuit, advantageously in respect of installation space and dimensions. These heat exchangers are arranged here in further, separate cooling circuits or in a further, separate third cooling circuit, or are arranged in the same cooling circuit of the charge converter, in particular before the at least one heat exchanger of the energy accumulator as considered from the central cooling system. Alternatively, they may be arranged in turn on a cooling plate, in particular a cooling plate common to the charge converters. The on-board network converter is used to convert the electrical energy of the stationary power network, for example a 750 V DC voltage, into an on-board network voltage, for example a 460 V three-phase AC current. The charging device for the on-board network battery serves similarly for the conversion of the network voltage of the stationary power network, for example of a 750 V DC voltage, into another DC voltage, for example a 24 V DC voltage. The charge converter in turn converts the network voltage into a predefined charging voltage for the at least one energy accumulator. An on-board network battery is a further energy accumulator, which is to be distinguished from the mode of action of the energy accumulator for the electric drive. The heat exchanger of the on-board network converter may be integrated therein. Similarly, the charging device and the heat exchanger of the charging device for the on-board network battery may also be an integrated component.

In accordance with a further development the vehicle also comprises at least one passive, inductive power component, which is arranged after a condenser of the central cooling system in an airflow, starting from a fan of the central cooling system. The airflow is heated only slightly by the condenser, for example by 20 K-30 K. This temperature increase is tolerable. The use of the exhaust airflow of the condenser here spares the arrangement of a further separate fan, and therefore space, weight and costs, and additionally reduces the development of noise.

As a result of the cooling with liquid coolant, a considerable reduction of the noise level is to be anticipated by the saving of a number of fans and blowers compared to the air cooling of charge converters, on-board network converters, charging device for the on-board network battery, traction power converters and/or power components, whereby the reliability and availability thereof is also improved, in particular in dusty or sandy environments. The energy efficiency of the cooling is additionally increased.

In a development, the central cooling system and the charge converter, and in particular the heat exchangers of the charge converter, are arranged in a common housing, for example a device container on the roof of the vehicle. This concentration may lead to a space saving.

The invention allows numerous embodiments. These will be explained in greater detail on the basis of the following figures, in each of which an exemplary embodiment is illustrated. Like elements in the figures are provided with like reference signs.

The vehicle according to the invention is in particular a rail vehicle, in particular for public transport, for example a low-floor tram, or a passenger or commercial road vehicle, such as a bus or a heavy goods vehicle.

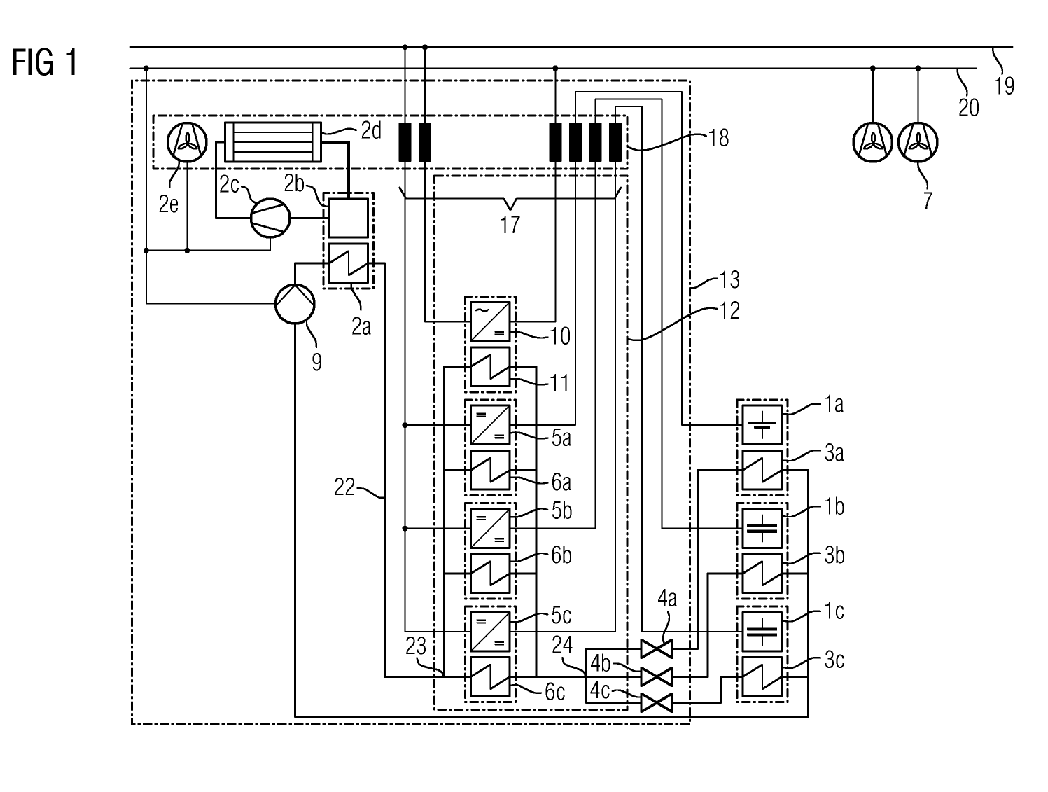

FIG. 1 schematically shows a circuit diagram of a central cooling system according to the invention with a connected cooling circuit,

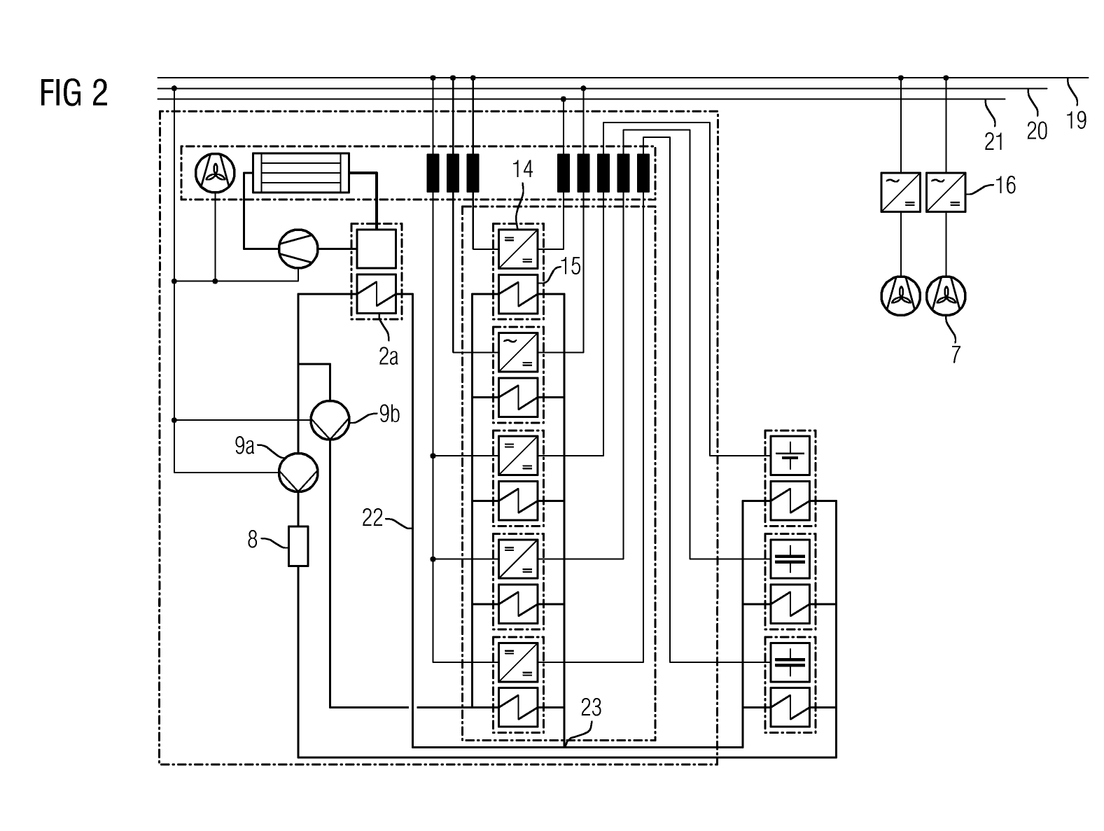

FIG. 2 schematically shows a circuit diagram of a variant of the invention.

FIG. 1 schematically shows a circuit diagram of an embodiment for cooling a vehicle in accordance with the invention. Besides an electric drive (not illustrated here), the vehicle comprises an energy accumulator, here comprising the storage elements 1a, 1b and 1c, and, for controlled charging and in particular also discharging of the storage elements 1a, 1b and 1c, charge converters 5a, 5b and 5c. The storage element 1a here is a battery, and the storage elements 1b and 1c are formed here as a capacitive accumulator.

For cooling both the storage elements 1a, 1b and 1c and the charge converters 5a, 5b and 5c, the vehicle has a central cooling system. In this exemplary embodiment the central cooling system comprises a refrigerating machine having a heat exchanger 2a, an evaporator 2b, a compressor 2c, a condenser 2d, and optionally having a choke (not illustrated here), and having a fan 2e. The heat exchanger 2a is coupled here on the one hand to the evaporator 2b. However, an embodiment with a simple water-air heat exchanger instead of the heat exchanger 2a is also possible. The heat exchanger 2a serves for the exchange of thermal energy between the refrigerating machine, in particular the evaporator 2b, and a closed cooling circuit 22, to which the heat exchanger 2a is coupled on the other hand. The closed cooling circuit 22 comprises pipes, filled with a liquid coolant.

The pipes of the cooling circuit 22 lead the coolant to the heat exchangers 6a, 6b and 6c, which are associated with the charge converters 5a, 5b and 5c. The heat exchangers 6a, 6b and 6c therefore serve to cool the respective charge converters 5a, 5b and 5c. Since here the heat exchangers 6a, 6b and 6c are not connected to one another in series, but in parallel, the closed cooling circuit 22 has branches 23. The coolant flow is firstly divided into individual strands. Once it has flowed through the heat exchangers 6a, 6b and 6c, the coolant is combined again. In order to control the coolant flow through the heat exchangers 6a, 6b and 6c and therefore the coolant feed to the individual heat exchangers 6a, 6b and 6c, valves can be arranged in the individual strands or at the branches 23. This may be expedient when charge converters or heat exchangers are spatially separated or the losses of the charge converters differ significantly from one another, however this is not provided here.

In the exemplary embodiment, accumulators having different physical operating principles and characteristics are shown, of which the power losses differ significantly from one another. Here, valves 4a, 4b and 4c are therefore also arranged further downstream after a further branching 24 of the closed cooling circuit 22 into the individual strands to heat exchangers 3a, 3b and 3c in order to control the coolant flow through the heat exchangers 3a, 3b and 3c and therefore the coolant feed to the individual heat exchangers 3a, 3b and 3c, which heat exchangers 3a, 3b and 3c are associated with the storage elements 1a, 1b and 1c and in turn serve to cool the respective storage elements 1a, 1b and 1c. Here too, once they have flowed through the heat exchangers 3a, 3b and 3c, the individual strands are combined again, such that, conveyed by a recirculating pump 9 in the closed cooling circuit 22, the coolant is then guided in an individual strand through the central heat exchanger 2a.

Starting from the central cooling system, the coolant thus flows initially through at least one heat exchanger 6a, 6b or 6c of the charge converters 5a, 5b and 5c in order to then flow back again to the central cooling system through at least one heat exchanger 3a, 3b or 3c of the storage elements 1a, 1b and 1c. Reference is therefore made to a common cooling circuit 22 for the charge converters 5a, 5b and 5c and the storage elements 1a, 1b and 1c. The coolant is the thus preheated by the power losses of the charge converters, which is generally tolerable, since the losses of the power electronics are small compared with the charge power losses in the storage elements.

The vehicle in this exemplary embodiment is a multi-part public transport rail vehicle. This vehicle is supplied with electrical energy from a stationary power network 19. A connection to this power network 19 is established via a current collector (not shown here). By way of example, the power network is a 750 V DC voltage network. The storage elements 1a, 1b and 1c are connected to the power network via the charge converters 5a, 5b and 5c and via further, in particular passive, inductive power components 17, such as transformers or filter chokes. In order to supply energy to further consumers, such as here also the electrical consumers of the central cooling system, the fan 2e or the compressor 2c, the vehicle has at least one on-board network converter 10 for converting the power type of the power network into a predefined power type of the on-board network, for example a 460 V three-phase alternating current. The on-board network converter 10 is likewise connected to the stationary power network 19, possibly via a power component 17.

The passive, inductive power components 17 are arranged in and cooled by an airflow generated by the fan 2e of the central cooling system. An air channel 18 for guiding the airflow is provided for this purpose. It is thus possible to dispense with further fans.

Besides the fan 2e or the compressor 2c of the central cooling system, fans 7 for traction containers of the rail vehicle are connected to the on-board network 20. By way of example, traction converters are housed in the traction containers.

In order to cool the on-board network converter 10, a heat exchanger 11 is associated here therewith, which heat exchanger is likewise arranged in the closed cooling circuit 22. Accordingly, the on-board network converter 10 is also cooled by the central cooling system instead of using cooling elements or fans, which usually require a considerable amount of space or are bulky, for cooling with air. The on-board network converter 10 and the heat exchanger 11 for the on-board network converter 10 are additionally mounted in this exemplary embodiment on a common cooling plate 12 with heat exchangers 6a, 6b and 6c and charge converters 5a, 5b and 5c.

The central cooling system is in turn preferably arranged together with the on-board network converter 10 and the heat exchanger 11 of the on-board network converter 10, the charge converters 5a, 5b and 5c and the heat exchangers 6a, 6b and 6c of the charge converters 5a, 5b and 5c on a common carriage part, in particular in a common housing 13, for example a device container on the roof of the rail vehicle, such that complex carriage transitions with tubes, etc. are avoided.

If the central cooling system is used to cool the liquid coolant of the cooling circuit 22, it forms a heat sink, and the storage elements 1a, 1b and 1c and charge converters 5a, 5b and 5c to be cooled form heat sources, which heat the coolant. In a possible inverse operation, for example in the event of standby or start-up at low ambient temperatures, the central cooling system by contrast may form a heat source, and the storage elements 1a, 1b and 1c via the heat exchangers 3a, 3b and 3c may form the heat sink, whereby they are held in their optimal working temperature range. An arrangement of a heating element 8 in the cooling circuit, in particular after the central heat exchanger 2a and before the heat exchangers 3a, 3b and 3c of the storage elements 1a, 1b and 1c and/or before the heat exchangers 6a, 6b and 6c of the charge converters 5a, 5b and 5c is also possible.

FIG. 2 shows a further embodiment for cooling in accordance with the invention the storage elements 1a, 1b and 1c of the energy store and the corresponding charge converters 5a, 5b and 5c of the vehicle in a schematic circuit diagram.

A closed cooling circuit 22 is connected to the central cooling system via the central heat exchanger 2a of the central cooling system. Here too, the cooling circuit 22 branches into a number of strands, which supply the heat exchangers 6a, 6b and 6c of the charge converters 5a, 5b and 5c with coolant. Separately from this, the heat exchangers 3a, 3b or 3c of the storage elements 1a, 1b and 1c are also supplied by individual strands. The coolant flows, however, are returned separately from one another in two separate strands, conveyed by a recirculating pump 9a or 9b respectively in the two separate strands, but combined again before the central heat exchanger 2a. In the strand guiding the return flow of the coolant from the heat exchangers 3a, 3b or 3c of the storage elements 1a, 1b and 1c, a heating element 8 is arranged after the heat exchangers 3a, 3b or 3c of the storage elements 1a, 1b and 1c and before the recirculating pump 9a, as considered from the central cooling system. The heating element 8 is provided to heat the coolant in order to preheat the storage elements 1a, 1b and 1c of the energy accumulator to a predefined operating temperature. The cooling system of course does not act as a heat sink during operation of the heating element 8. In particular, the cooling system is switched off. Additionally to the heating element 8 or alternatively thereto, the cooling system that may also be operated inversely and therefore in order to heat the coolant.

Alternatively to the illustrated design, the vehicle could comprise two cooling circuits different from one another and separate from one another, wherein one of these cooling circuits comprises the heat exchangers for the charge converters, and wherein the other of these cooling circuits comprises the heat exchangers for the storage elements. The coolant flows of the two different and separate cooling circuits could also be moved using a common recirculating pump.

Similarly to FIG. 1, the flow of coolant to the individual heat exchangers of the energy store may be controlled by means of valves in order to set the optimal operating temperature for each storage element of the energy accumulator in accordance with the momentary thermal load thereof.

In addition to the charge converters 5a, 5b and 5c and the on-board network converter 10, the vehicle comprises a further power converter, here a DC voltage converter 14 for supplying 24 V DC voltage consumers of the vehicle. By way of simplification, the DC voltage converter 14 is illustrated here by way of representation for a charging device for an on-board network battery. The DC voltage converter 14 is in turn connected via power components 17 to the stationary power network 19. Furthermore, a heat exchanger 15 is associated therewith for cooling thereof. However, both the DC voltage converter 14 and the heat exchanger 15 are arranged together with the heat exchangers 6a, 6b and 6c, the charge converters 5a, 5b and 5c, the on-board network converter 10 and the heat exchanger 11 for the on-board network converter 10 on the common cooling plate 12 and are arranged together with the central cooling system in the common device container 13 on the roof of the vehicle.

The fans 7 of the traction arrangements of the vehicle are supplied here with energy from the stationary power network 19 by dedicated, local power converters 16. Further large consumers of the vehicle, such as air-conditioning systems, may also be housed on other vehicle parts and may be cooled generally independently of the central cooling system, in particular by means of separate fans.

A further embodiment is provided in that, depending on the arrangement possibilities in the vehicle, further power-converting arrangements, such as traction power converters, are cooled by means of the central cooling system, in particular in that the traction power converters are arranged in the cooling circuit, similarly to the on-board network converter.

1-11. (canceled)

12. A vehicle, comprising:
at least one electric drive;
at least one energy accumulator for supplying said electric drive with energy;
at least one current collector for charging said energy accumulator with electrical energy from a stationary power network;
at least one charge converter connected between said current collector and said energy accumulator for controlled charging of said energy accumulator; and
a central cooling system and at least one closed cooling circuit with liquid coolant configured to cool said energy accumulator and said charge converter.

13. The vehicle according to claim 12, wherein said cooling circuit comprises at least one heat exchanger for said energy accumulator and at least one heat exchanger for said charge converter, wherein said heat exchanger for said charge converter is arranged before said heat exchanger of said energy accumulator, starting from said central cooling system.

14. The vehicle according to claim 13, wherein said cooling circuit comprises a first cooling circuit and a different, second cooling circuit each with liquid coolant and different from one another, wherein said at least one heat exchanger for said energy accumulator is arranged in said first cooling circuit, and wherein said at least one heat exchanger for said charge converter is arranged in said second cooling circuit.

15. The vehicle according to claim 13, which comprises at least one valve configured to control a coolant flow through at least one heat exchanger, said at least one valve being arranged in said cooling circuit before said at least one heat exchanger in a liquid flow from said central cooling system.

16. The vehicle according to claim 13, wherein one or both of the following are true:
said at least one heat exchanger is one of a plurality of heat exchangers for said at least one charge converter; and
said at least one heat exchanger is one of a plurality of heat exchangers for said at least one energy accumulator.

17. The vehicle according to claim 12, which further comprises at least one on-board network converter and at least one heat exchanger in said cooling circuit for cooling said on-board network converter.

18. The vehicle according to claim 17, wherein said heat exchanger of said on-board network converter is identical to a heat exchanger of said charge converter.

19. The vehicle according to claim 12, which comprises a heating element for heating the liquid coolant in said at least one cooling circuit.

20. The vehicle according to claim 12, wherein said central cooling system comprises at least one condenser, at least one compressor, and at least one evaporator.

21. The vehicle according to claim 12, wherein said central cooling system and said at least one charge converter are arranged in a common device container of the vehicle.

22. The vehicle according to claim 12, which comprises at least one passive, inductive power component arranged in an airflow after a condenser of said central cooling system, starting from a fan of said central cooling system.
